(19) United States
(12) Patent Application Publication
(10) Pub. No.: US 2006/0165108 A1
(43) Pub. Date: Jul. 27, 2006

(54) METHOD AND SYSTEM FOR UNIDIRECTIONAL PACKET PROCESSING AT DATA LINK LAYER

(75) Inventor: Sezen Uysal, Vienna, VA (US)

Correspondence Address: SEZEN UYSAL, 9318 KILBY GLEN DR., VIENNA, VA, 22182, US

(73) Assignee: Mr. Sezen Uysal, Vienna, VA (US)

(21) Appl. No.: 10/905,809

(22) Filed: Jan. 21, 2005

(51) Int. Cl. H04L 12/56

(52) U.S. Cl. 370/412

(57) ABSTRACT

A method and system for data link layer packet processing which unidirectionaly captures, filters, enqueues, processes and forwards packets between multiple network interfaces are introduced. Fast and intelligent data link layer network applications or equipment can implemented by programming the invention. Each direction of packet flow in this system is independently processed from others. This feature provides very flexible packet processing and very fast packet forwarding since each flow can be implemented in an isolated process, application or a device. As the system operates at OSI model's data link layer (e.g. Ethernet), installing the system into a functional network does not require any change in the configuration of network applications or equipment. This system can be utilized for employing various networking functions such as network emulation, bridging, firewall, virus detection, bandwidth management, traffic monitoring and in-line intrusion detection, etc.

### BACKGROUND OF INVENTION

As new applications and networking technologies are introduced, data communication is getting more complex. Realistically testing new applications and increasing security towards new attacks while maintaining the quality of services are becoming very challenging. In addition, as the network connection speed increases real-time traffic monitoring and bandwidth management operations are harder to implement without sacrificing the performance.

The issues outlined above require more intelligent and faster network equipment that can examines the data packets and make smart decisions at high speeds. These devices need to work at high speed without any negative impact to the quality of existing applications and services. In addition, some of the functions such as bandwidth management and traffic monitoring require operations at data link layer (e.g. Ethernet).

Presently known devices are designed to address only some of the issues mentioned above. They can either operate at very high speeds without any packet processing capabilities or they can do limited processing at very low speeds. High speed solutions are implemented in specialized hardware such as network processors which can forward packets very fast. However as they are limited with their design they cannot be used for new applications or requirements. Whereas the low speed models work like a generic proxy servers which are designed to function for a limited purpose such as firewall, or bandwidth manager. Adding new capabilities is very hard. Also they cannot operate at the desired high speeds due to inflexible architecture.

### SUMMARY OF INVENTION

A method and system for data link layer packet processing which unidirectionaly captures, filters, enqueues, processes and forwards packets between multiple network interfaces are introduced. The system handles each direction of packet flow independently. This way each traffic flow can be implemented in a separate process, application or even a device. Communication between traffic flows can be implemented via standard Inter Process Communication (IPC) technologies such as shared memory, Application Programming Interface (API), etc. This feature enables the system to be implemented on any hardware to optimize the processing speeds. It would also make it very portable to any operating system or CPU type.

As the system operates at OSI model's data link layer (e.g. Ethernet), installing the system into a functional network does not require any change in the configuration of network applications or equipment.

This system can be utilized as the platform for employing various networking functions such as network emulation, bridging firewall, virus detection, bandwidth management, traffic monitoring and in-line intrusion detection, etc. All of these functions can be implemented very easily by programming the invention.

### BRIEF DESCRIPTION OF DRAWINGS

FIG. 1 depicts preferred embodiment of the invention utilized to process data packets exchanged between communication networks.

FIG. 2 depicts the system architecture in which each traffic flow is processed independently.

FIG. 3 shows the traffic flow on one direction in detail.

### DETAILED DESCRIPTION

The preferred embodiment of the present invention is implemented in a system with two network interfaces. Each interface is connected to a network segment and would capture, process packets and forward them to the other interface.

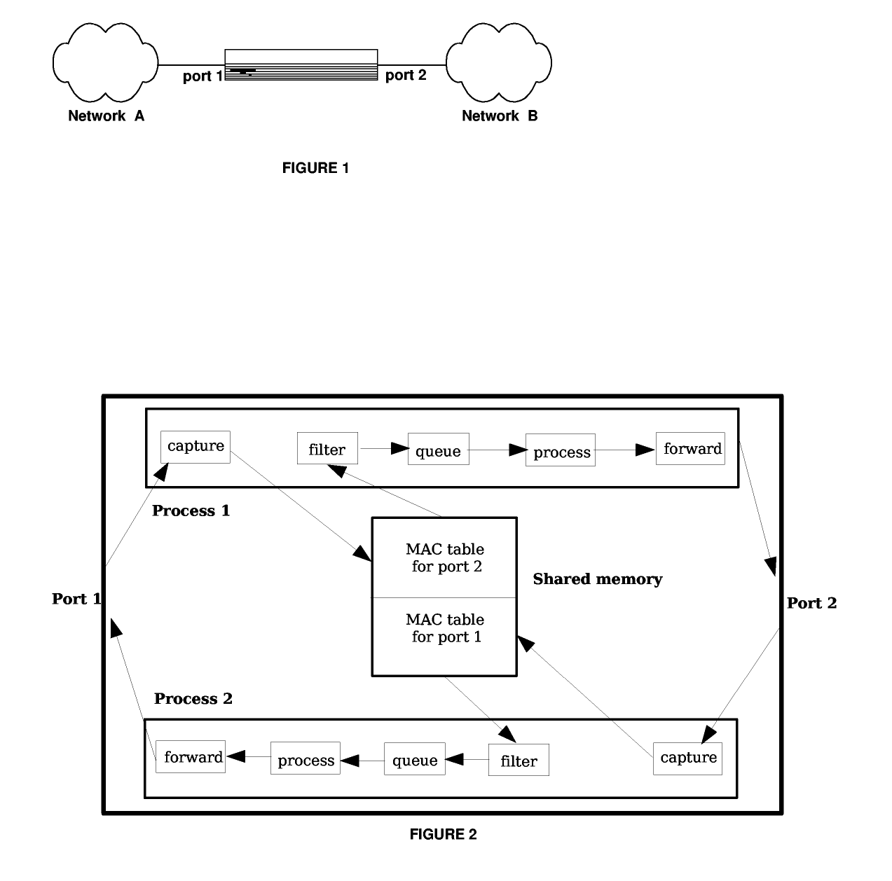

FIG. 1 shows a typical setup of the invention. In that example, the invention is connecting two networks at data link level. While forwarding packets to other network, it is capable of examining the packets, filtering them, as well as modifying certain protocol fields. The invention can be programmed to perform any combination of the mentioned functions to implement a specific networking requirement.

The invention handles each direction of the traffic independently. Each direction can have separate program for packet capturing, filtering, queuing, processing and forwarding. In addition, each direction can be implemented in a separate operating system process, or an application. This feature provides ultimate flexibility in implementing unique functions at very high processing speeds by using multi-processing hardware.

FIG. 2. depicts the invention in a block diagram in which each direction of the traffic is implemented in a separate operating system process. While one process is capturing packets from a port the other one is forwarding to the same port. These processes communicate with each other by the use of a shared memory. In one embodiment the shared memory is used to implement MAC tables. In another one it can be used to pass signals between two processes to implement a complex networking equipment such as a proxy server.

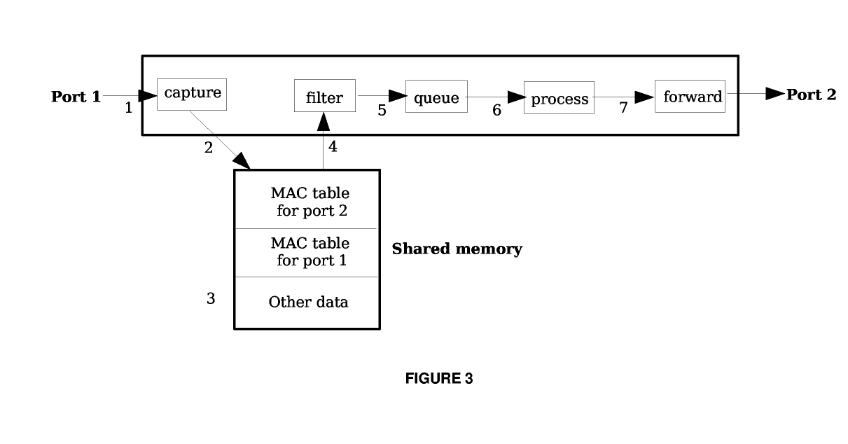

FIG. 3. shows the diagram of a process that handles only one direction of the traffic. First, the process captures a packet from port 1 that it is assigned to (1). Then it consults the MAC table for port 2 to check whether the packet is actually received from the network (2). It does this by comparing the source MAC address of the packet with port-2 MAC table which contains the MAC addresses of the nodes on the port 2 side of the network. This check is required for Ethernet implementations as Ethernet drivers capture not only the packets received from the network but also the ones sent to the network. Clearly, the packets sent to the network from this interface need to be dropped otherwise they would cause infinite looping of packets.

After validating that the packet is really from the network, the process can also do some specific signaling with the other process by using some other portion of the shared memory (3). In one embodiment, this capability can be used to block the traffic in one direction based on some conditions on the other direction.

Next, the process implements a filtering function to pick and choose certain packets (4). Filtering function uses a filter set which consists of a single or multiple filters which can be combined with logical AND, OR, NOT operations. In one embodiment, packets matching the filters are forwarded to the packet processing functions. The ones that do not match are forwarded to the port 2.

The process can also implement queuing function in case packet processing introduces latency to the traffic flow (5). The variable queue size needs to be set appropriately to implement the desired latency and packet loss balance. If the queue size is small the latency introduced by queuing will be low. However with bursty packet arrivals some packet loss may occur due to queue overflow. On the other hand, if the queue is large then packet loss will be low but the latency introduced by queuing might be higher.

The next stop is packet processing (6). This is typically where the specific networking function can be implemented. In one embodiment, the processing function can simply delay every single packet to emulate network delay within a real network. In another embodiment, the processing function can modify certain protocol fields inside the packet for a specific purpose.

The final step is the forwarding the packet into the network through port 2 (7). The speed of forwarding is set by modifying the port parameters.

What is claimed is:

1. A system for unidirectionaly processing packets at data link layer, said system comprising: two or more network ports, and two or more processes that can perform any combinations of promiscuous packet capturing, filtering, enqueuing, packet processing and forwarding functions on each direction of the traffic; said system using shared memory to register MAC addresses of the network nodes at each said system ports; said system using shared memory for signaling between processes.

2. A system as claimed in claim 1 wherein said unidirectionaly processing is receiving packets from one port, performing some functions on them, then sending them to another port.

3. A system as claimed in claim 1 wherein said data link layer can comprises any combinations of Ethernet, ATM, Frame Relay, HDLC, X.25, Token Ring, AppleTalk, MPLS and VLAN protocols.

4. A system as claimed in claim 1 wherein said processes are operating system processes or software applications residing in the same computing environment.

5. A system as claimed in claim 1 wherein said filtering uses a filter set that comprises a single or multiple packet filters that can operate on any data communication protocols, said filters are combined in a filter set with logical AND, OR, NOT operations.

6. A system as claimed in claim 1 wherein said packet processing is a combination of packet modification, packet delaying, packet dropping, packet duplication, and packet reordering functions.

7. A system as claimed in claim 1 wherein said processes are handling one direction of the traffic independently from other directions, said processes communicate with each other through the shared memory to implement complex tasks.

8. A system as claimed in claim 1 wherein said MAC addresses are registered in the shared memory in the form of MAC tables for each port, said MAC tables are used to decide whether a captured packet is from the network but not previously transmitted packet, said previously transmitted packet is dropped to eliminate disturbing traffic loops.

9. A system as claimed in claim 1 can be programmed further to implement various networking functions such as firewall, bridging, proxy server, network emulation, traffic monitoring, bandwidth throttling, DNS server.

10. A method for unidirectionaly processing packets at data link layer, said method comprising: two or more network interfaces, and two or more processes that can perform any combinations of promiscuous packet capturing, filtering, enqueuing, packet processing and forwarding functions on each direction of the traffic; said method using shared memory to register MAC addresses of the network nodes at each said method interfaces; said method using shared memory for signaling between processes.

11. A method as claimed in claim 1 wherein said unidirectionaly processing is receiving packets from one port, performing some functions on them, then sending them to another port.

12. A method as claimed in claim 1 wherein said filtering uses a filter set that comprises a single or multiple packet filters that can operate on any data communication protocols, said filters are combined in a filter set with logical AND, OR, NOT operations.

13. A method as claimed in claim 1 wherein said packet processing is a combination of packet modification, packet delaying, packet dropping, packet duplication, and packet reordering functions.

14. A method as claimed in claim 1 wherein said processes are handling one direction of the traffic independently from other directions, said processes communicate with each other through the shared memory to implement complex tasks.

15. A method as claimed in claim 1 wherein said MAC addresses are registered in the shared memory in the form of MAC tables for each port, said MAC tables are used to decide whether a captured packet is from the network but not previously transmitted packet, said previously transmitted packet is dropped to eliminate disturbing traffic loops.

16. A computer program product for unidirectionaly processing packets at data link layer, said computer program product comprising: two or more network ports, and two or more processes that can perform any combinations of promiscuous packet capturing, filtering, enqueuing, packet processing and forwarding functions on each direction of the traffic; said computer program product using shared memory to register MAC addresses of the network nodes at each said ports; said computer program product using shared memory for signaling between processes.

17. A computer program product as claimed in claim 1 wherein said unidirectionaly processing is receiving packets from one port, performing some functions on them, then sending them to another port.

18. A computer program product as claimed in claim 1 wherein said data link layer comprises any combination of Ethernet, ATM, Frame Relay, HDLC, X.25, Token Ring, AppleTalk, MPLS and VLAN protocols.

19. A computer program product as claimed in claim 1 wherein said processes are operating system processes or software applications residing in the same computing environment.

20. A computer program product as claimed in claim 1 wherein said filtering uses a filter set that comprises a single or multiple packet filters that can operate on any data communication protocols, said filters are combined in a filter set with logical AND, OR, NOT operations.

21. A computer program product as claimed in claim 1 wherein said packet processing is a combination of packet modification, packet delaying, packet dropping, packet duplication, and packet reordering functions.

22. A computer program product as claimed in claim 1 wherein said processes are handling one direction of the traffic independently from other directions, said processes communicate with each other through the shared memory to implement complex tasks.

23. A computer program product as claimed in claim 1 wherein said MAC addresses are registered in the shared memory in the form of MAC tables for each port, said MAC tables are used to decide whether a captured packet is from the network but not previously transmitted packet, said previously transmitted packet is dropped to eliminate disturbing traffic loops.

24. A computer program product as claimed in claim 1 can be programmed further to implement various networking functions such as firewall, bridging, proxy server, network emulation, traffic monitoring, bandwidth throttling, DNS server.
